(19) United States
(12) Patent Application Publication
(10) Pub. No.: US 2015/0244586 A1
(43) Pub. Date: Aug. 27, 2015

(54) Network Provisioning And Deployment

(71) Applicant: COMCAST CABLE COMMUNICATIONS, LLC, Philadelphia, PA (US)

(72) Inventors: Yiu Leung Lee, Philadelphia, PA (US); Clifton Lowery, Philadelphia, PA (US); Franklyn Athias, Cherry Hill, NJ (US); Ivan Ong, Malvern, PA (US)

(73) Assignee: COMCAST CABLE COMMUNICATIONS, LLC, Philadelphia, PA (US)

(21) Appl. No.: 14/188,084

(22) Filed: Feb. 24, 2014

(51) Int. Cl. H04L 12/24

(52) U.S. Cl. CPC H04L 41/50

(57) ABSTRACT

Systems and methods for managing a network are disclosed. One method can comprise storing an identifier associated with one or more of a user device and a first network device. The first network device can be at a first location and can be configured to establish a connection between the user device and a first network. A request to connect can be received from the user device via a second network. The identifier can be provided in response to the request, wherein the identifier facilitates data transmission as if the user device was connected to the first network via the first network device.

### BACKGROUND

A network, such as a local area network, can comprise one or more network devices (e.g., access points (APs)) to provide a means for one or more user devices to communicate with and/or over the network. A network device allows wired and/or wireless user devices to connect to a wired network using Wi-Fi, Bluetooth, or related standards. A network device can be configured to provide access to one or more services (e.g., private network, public network, network-related services). As an example, a network device can be configured to provide one or more services exclusively to a local area network (LAN) such as a home network. Accordingly, improvements are needed for a network to configure and provide services for various devices such as exclusive services for selected devices. These and other shortcomings are addressed by the present disclosure.

### SUMMARY

It is to be understood that both the following general description and the following detailed description are exemplary and explanatory only and are not restrictive, as claimed. Provided are methods and systems for providing services (e.g., network connectivity, broadband services, etc.) to one or more user devices or clients. The methods and systems described herein, in one aspect, can provide access to one or more services by one or more user devices or clients independent of the LAN to which the user devices are connected.

In an aspect, methods can comprise storing an identifier associated with one or more of a user device and a first network device. The first network device can be disposed at a first location. The first network device can be configured to establish or facilitate a connection between the user device and a network. A request to connect the user device to the network via a second network device can be received. The second network device can be disposed at a second location. The first location and the second location can be different and/or can relate to the same area. The identifier can be provided (e.g., provisioned, assigned, transmitted) to the user device in response to the request. The identifier can facilitate connection to the network as if the user device was connected to the network via the first network device.

In another aspect, methods can comprise receiving an access request from a user device, wherein the user device is associated with a first identifier. The first identifier can be compared with a stored second identifier. If the first identifier matches the stored second identifier, a stored third identifier can be provided (e.g., provisioned, assigned) to the user device to satisfy the access request. If the first identifier is different from the stored second identifier, a fourth identifier can be provided to the user device to satisfy the access request, wherein the stored third identifier is different from the fourth identifier.

In a further aspect, methods can comprise providing access to a first network via a first network device. A first identifier associated with a user device can be received. The first identifier can be mapped to a second identifier. The second identifier can be associated with the first network device. Access to the first network can be provided via a second network device using one or more of the first identifier and the second identifier.

In certain aspects, when a device connects to a network such as a LAN associated with a first SSID, a network device (e.g., gateway device, computing device, server, router, etc.) can generate or receive a mapping object such as an address mapping pair (e.g., <mac-address, IP address>) associated with the device. The mapping object can comprise any number of associated identifiers such as addresses. As an example, the IP address associated with the device can be local to the gateway or network that generated the mapping object. Subsequently, when the user device associates (e.g., connects) with a network (first network or other network), a network device can check an identifier (e.g., MAC address) associated with the user device against one or more mapping objects. If the device identifier is located in the one or more mapping objects, the local identifier (e.g., IP address of the matching mapping object) can be provisioned to the user device even though the user device may have associated with a network other than the first network. Network devices can make packet forwarding decisions (or policy) based on the provisioned local identifier rather than VLANTAG or SSID. As such, the network interacts with the user device as if the user device was connected to the first network (e.g., home network). Services that are normally exclusively available at the first network can then be accessed outside the first network.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an exemplary system and network:

FIG. 2 is a block diagram of an exemplary computing device:

FIG. 3 is a diagram of an exemplary system and network:

FIG. 4 is a diagram of an exemplary system and network:

FIG. 5 is a flow chart of an exemplary method;

FIG. 6 is a flow chart of an exemplary method; and

FIG. 7 is a flow chart of an exemplary method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to.” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded on a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The methods and systems described herein, in one aspect, can provide services (e.g., network connectivity, broadband services, etc.) to one or more user devices or clients. The methods and systems described herein, in one aspect, can provide access to one or more services by one or more user devices or clients independent of the LAN to which the user devices are connected. As an example, when a device connects to a network such as a LAN associated with a first SSID, a network device (e.g., gateway device, computing device, server, router, etc.) can generate or receive a mapping object such as an address mapping pair (e.g., <mac-address, IP address>) associated with the device. The mapping object can comprise any number of associated identifiers such as addresses. As an example, the IP address associated with the device can be local to the gateway or network that generated the mapping object. Subsequently, when the user device associates (e.g., connects) with a network (first network or other network), a network device can check an identifier (e.g., MAC address) associated with the user device against one or more mapping objects. As an example, the check can be executed via a DHCP request. If the device identifier is located in the one or more mapping objects, the local identifier (e.g., IP address of the matching mapping object) can be provisioned to the user device even though the user device may have associated with a network other than the first network. Network devices can make packet forwarding decisions (or policy) based on the provisioned local identifier rather than VLANTAG or SSID. As such, the network interacts with the user device as if the user device was connected to the first network (e.g., home network). Services that are normally exclusively available at the first network can then be accessed outside the first network.

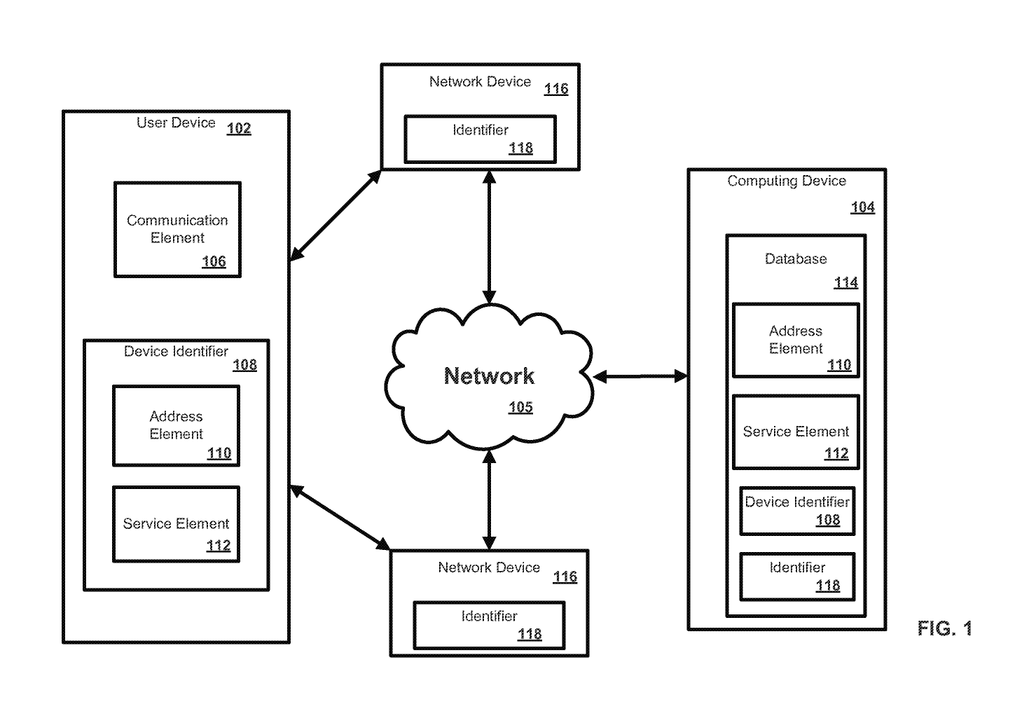

In one aspect of the disclosure, a system can be configured to provide services such as network-related services. FIG. 1 illustrates various aspects of an exemplary environment in which the present methods and systems can operate. The present disclosure is relevant to systems and methods for providing services to a user device, for example. Those skilled in the art will appreciate that present methods may be used in various types of networks and systems that employ both digital and analog equipment. One skilled in the art will appreciate that provided herein is a functional description and that the respective functions can be performed by software, hardware, or a combination of software and hardware.

The network and system can comprise a user device 102 in communication with a computing device 104 such as a server, for example. The computing device 104 can be disposed locally or remotely relative to the user device 102. As an example, the user device 102 and the computing device 104 can be in communication via a private and/or public network 105 such as the Internet. Other forms of communications can be used such as wired and wireless telecommunication channels, for example.

In an aspect, the user device 102 can be an electronic device such as a computer, a smartphone, a laptop, a tablet, a set top box, a display device, or other device capable of communicating with the computing device 104. As an example, the user device 102 can comprise a communication element 106 for providing an interface to a user to interact with the user device 102 and/or the computing device 104. The communication element 106 can be any interface for presenting information to the user and receiving a user feedback such as a application client or a web browser (e.g., Internet Explorer, Mozilla Firefox, Google Chrome. Safari, or the like). Other software, hardware, and/or interfaces can be used to provide communication between the user and one or more of the user device 102 and the computing device 104. As an example, the communication element 106 can request or query various files from a local source and/or a remote source. As a further example, the communication element 106 can transmit data to a local or remote device such as the computing device 104.

In an aspect, the user device 102 can be associated with a user identifier or device identifier 108. As an example, the device identifier 108 can be any identifier, token, character, string, or the like, for differentiating one user or user device (e.g., user device 102) from another user or user device. In a further aspect, the device identifier 108 can identify a user or user device as belonging to a particular class of users or user devices. As a further example, the device identifier 108 can comprise information relating to the user device such as a manufacturer, a model or type of device, a service provider associated with the user device 102, a state of the user device 102, a locator, and/or a label or classifier. Other information can be represented by the device identifier 108.

In an aspect, the device identifier 108 can comprise an address element 110 and a service element 112. In an aspect, the address element 110 can be an internet protocol address, a MAC address, a network address, an Internet address, or the like. As an example, the address element 110 can be relied upon to establish a communication session between the user device 102 and the computing device 104 or other devices and/or networks. As a further example, the address element 110 can be used as an identifier or locator of the user device 102. In an aspect, the address element 110 can be persistent for a particular network and/or location.

In an aspect, the service element 112 can comprise an identification of a service provider associated with the user device 102 and/or with the class of user device 102. As an example, the service element 112 can comprise information relating to or provided by a communication service provider (e.g., Internet service provider) that is providing or enabling communication services to the user device 102. As a further example, the service element 112 can comprise information relating to a preferred service provider for one or more particular services relating to the user device 102. In an aspect, the address element 110 can be used to identify or retrieve the service element 112, or vise versa. As a further example, one or more of the address element 110 and the service element 112 can be stored remotely from the user device 102 and retrieved by one or more devices such as the user device 102 and the computing device 104. Other information can be represented by the service element 112.

In an aspect, the computing device 104 can be a server for communicating with the user device 102. As an example, the computing device 104 can communicate with the user device 102 for providing services. In an aspect, the computing device 104 can allow the user device 102 to interact with remote resources such as data, devices, and files. As an example, the computing device can be configured as central location (e.g., a headend, or processing facility), which can receive content (e.g., data, input programming) from multiple sources. The computing device 104 can combine the content from the various sources and can distribute the content to user (e.g., subscriber) locations via a distribution system.

In an aspect, the computing device 104 can manage the communication between the user device 102 and a database 114 for sending and receiving data therebetween. As an example, the database 114 can store a plurality of data sets (e.g., mapped identifiers, relational tables, user device identifiers) (e.g., identifier 108) or records, network device identifiers (e.g., identifier 118), or other information. As a further example, the user device 102 can request and or retrieve a file from the database 114. In an aspect, the database 114 can store information relating to the user device 102 such as the address element 110 and/or the service element 112. As an example, the computing device 104 can obtain the device identifier 108 from the user device 102 and retrieve information from the database 114 such as the address element 110 and/or the service elements 112. As another example, the computing device 104 can obtain the address element 110 from the user device 102 and can retrieve the service element 112 from the database 114, or vice versa. As a further example, the computing device 104 can obtain a MAC address from the user device 102 and can retrieve a local IP address from the database 114. As such, the local IP address can be provisioned to the user device 102, for example, as the address element 110 to facilitate interaction between the user device 102 and a network (e.g., LAN). Any information can be stored in and retrieved from the database 114. The database 114 can be disposed remotely from the computing device 104 and accessed via direct or indirect connection. The database 114 can be integrated with the computing system 104 or some other device or system.

In an aspect, one or more network devices 116 can be in communication with a network such as network 105. As an example, one or more of the network devices 116 can facilitate the connection of a device, such as user device 102, to the network 105. As a further example, one or more of the network devices 116 can be configured as a network gateway. In an aspect, one or more network devices 116 can be configured to allow one or more wireless devices to connect to a wired and/or wireless network using Wi-Fi, Bluetooth or similar standard.

In an aspect, the network devices 116 can be configured as a mesh network. As an example, one or more network devices 116 can comprise a dual band (or more) wireless network device. As an example, the network devices 116 can be configured with a first service set identifier (SSID) (e.g., associated with a user network or private network) to function as a local network for a particular user or users. As a further example, the network devices 116 can be configured with a second service set identifier (SSID) (e.g., associated with a public/community network or a hidden network) to function as a secondary network or redundant network for connected communication devices.

In an aspect, one or more network devices 116 can comprise an identifier 118. As an example, one or more identifiers can be a media access control address (MAC address). As a further example, one or more identifiers 118 can be a unique identifier for facilitating communications on the physical network segment. In an aspect, each of the network devices 116 can comprise a distinct identifier 118. As an example, the identifiers 118 can be associated with physical locations of the network devices 116.

In an aspect, the user device 102 can provide information such as identification information (e.g., device identifier 108, credentials, etc.) to one or more network devices 116. As an example, the user device 102 can request a service such a network service by providing information to the network device 116. In another aspect, the network device 116 can transmit the information received from the user device 102 to the computing device 104. As an example, the network device 116 can invoke a lookup algorithm to locate a record associated with the information provided by the user device 102. As a further example, the record can be located in service provider database (e.g., database 114). In a further aspect, the information provided by the user device 102 may be associated with an identifier of the network device 116. As an example, a database record can comprise a mapping of a device identifier (e.g., device identifier 108) and an identifier (e.g., identifier 118) associated with the network device 116.

In an aspect, when the user device 102 connects to a first network such as a LAN associated with a first SSID, a network device (e.g., network device 116, gateway device, computing device 104, server, router, etc.) can generate or receive a mapping object such as static address mapping pair (e.g., <mac-address, IP address>) associated with the user device 102. As an example, a MAC address associated with the user device 102 can be mapped to an IP address that is associated with the LAN (e.g., home network) to which the user device 102 initially connected. As a further example, the IP address provisioned to the user device 102 can be a local IP address associated with the network device that generated the mapping object. Subsequently, when the user device 102 associates (e.g., connects) with a network (first network or other network), a network device can check a device identifier (e.g., MAC address) associated with the user device 102 against one or more mapping objects (e.g., stored at database 114). As an example, the check can be executed via a DHCP request from the user device 102. If the device identifier is located in the one or more mapping objects, the local identifier (e.g., IP address of the matching mapping object) can be provisioned to the user device 102 even though the user device 102 may have associated to a network other than the first network. Accordingly, network devices can make packet forwarding decision (or policy) based on the provisioned local identifier rather than a virtual local area network (VLAN) label (e.g., VLANTAG) or SSID. As such, multiple networks associated with different SSID's can interact with the user device 102 as if the user device 102 was connected to the first network (e.g., home network). Services that are normally exclusively available at the first network can then be accessed outside the first network since packet routing can be based on the provisioned local IP address to the user device 102. Such services can include local printing, local data storage and/or services provided via local media server. Such services can include service provided via a local discovery protocol such as DLNA or bonjour.

Conventionally, an identifier is provisioned to a device based on a particular network to which the device is connected. This allows upstream network device devices to address and route information to the appropriate device and through the appropriate network. The present disclosure can force a local identifier to be provisioned to a device in order to facilitate the delivery of local services to the device regardless of device location.

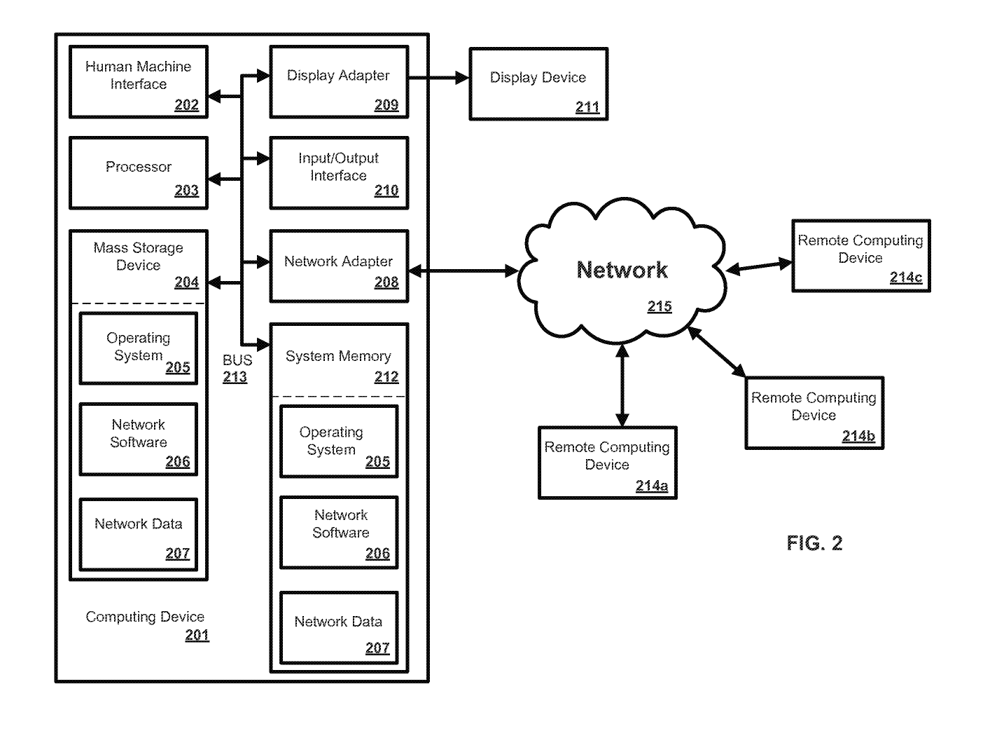

In an exemplary aspect, the methods and systems can be implemented on a computing system such as computing device 201 as illustrated in FIG. 2 and described below. By way of example, one or more of the user device 102 and the computing device 104 of FIG. 1 can be a computer as illustrated in FIG. 2. Similarly, the methods and systems disclosed can utilize one or more computers to perform one or more functions in one or more locations. FIG. 2 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices.

Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computing device 201. The components of the computing device 201 can comprise, but are not limited to, one or more processors or processing units 203, a system memory 212, and a system bus 213 that couples various system components including the processor 203 to the system memory 212. In the case of multiple processing units 203, the system can utilize parallel computing.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 213, and all buses specified in this description can also be implemented over a wired or wireless network connection and each of the subsystems, including the processor 203, a mass storage device 204, an operating system 205, network software 206, network data 207, a network adapter 208, system memory 212, an Input/Output Interface 210, a display adapter 209, a display device 211, and a human machine interface 202, can be contained within one or more remote computing devices 214a,b,c at physically separate locations, connected through buses of this form, in effect implementing a fully distributed system.

The computing device 201 typically comprises a variety of computer readable media. Exemplary readable media can be any available media that is accessible by the computing device 201 and comprises, for example and not meant to be limiting, both volatile and non-volatile media, removable and non-removable media. The system memory 212 comprises computer readable media in the form of volatile memory, such as random access memory (RAM), and/or non-volatile memory, such as read only memory (ROM). The system memory 212 typically contains data such as network data 207 and/or program modules such as operating system 205 and network software 206 that are immediately accessible to and/or are presently operated on by the processing unit 203.

In another aspect, the computing device 201 can also comprise other removable/non-removable, volatile/non-volatile computer storage media. By way of example, FIG. 2 illustrates a mass storage device 204 which can provide non-volatile storage of computer code, computer readable instructions, data structures, program modules, and other data for the computing device 201. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and network software 206. Each of the operating system 205 and network software 206 (or some combination thereof) can comprise elements of the programming and the network software 206. Network data 207 can also be stored on the mass storage device 204. Network data 207 can be stored in any of one or more databases known in the art. Examples of such databases comprise, DB2®, Microsoft®, Access, Microsoft® SQL Server, Oracle®, mySQL, PostgreSQL, and the like. The databases can be centralized or distributed across multiple systems.

In another aspect, the user can enter commands and information into the computing device 201 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 203 via a human machine interface 202 that is coupled to the system bus 213, but can be connected by other interface and bus structures, such as a parallel port, game port, an IEEE 1394 Port (also known as a Firewire port), a serial port, or a universal serial bus (USB).

In yet another aspect, a display device 211 can also be connected to the system bus 213 via an interface, such as a display adapter 209. It is contemplated that the computing device 201 can have more than one display adapter 209 and the computer 201 can have more than one display device 211. For example, a display device can be a monitor, an LCD (Liquid Crystal Display), or a projector. In addition to the display device 211, other output peripheral devices can comprise components such as speakers (not shown) and a printer (not shown) which can be connected to the computing device 201 via Input/Output Interface 210. Any step and/or result of the methods can be output in any form to an output device. Such output can be any form of visual representation, including, but not limited to, textual, graphical, animation, audio, tactile, and the like. The display 211 and computing device 201 can be part of one device, or separate devices.

The computing device 201 can operate in a networked environment using logical connections to one or more remote computing devices 214a,b,c. By way of example, a remote computing device can be a personal computer, portable computer, a smart phone, a server, a router, a network computer, a peer device or other common network node, and so on. Logical connections between the computing device 201 and a remote computing device 214a,b,c can be made via a network 215, such as a local area network (LAN) and a general wide area network (WAN). Such network connections can be through a network adapter 208. A network adapter 208 can be implemented in both wired and wireless environments. Such networking environments are conventional and commonplace in dwellings, offices, enterprise-wide computer networks, intranets, and the Internet.

For purposes of illustration, application programs and other executable program components such as the operating system 205 are illustrated herein as discrete blocks, although it is recognized that such programs and components reside at various times in different storage components of the computing device 201, and are executed by the data processor(s) of the computer. An implementation of network software 206 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM. ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based Al, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

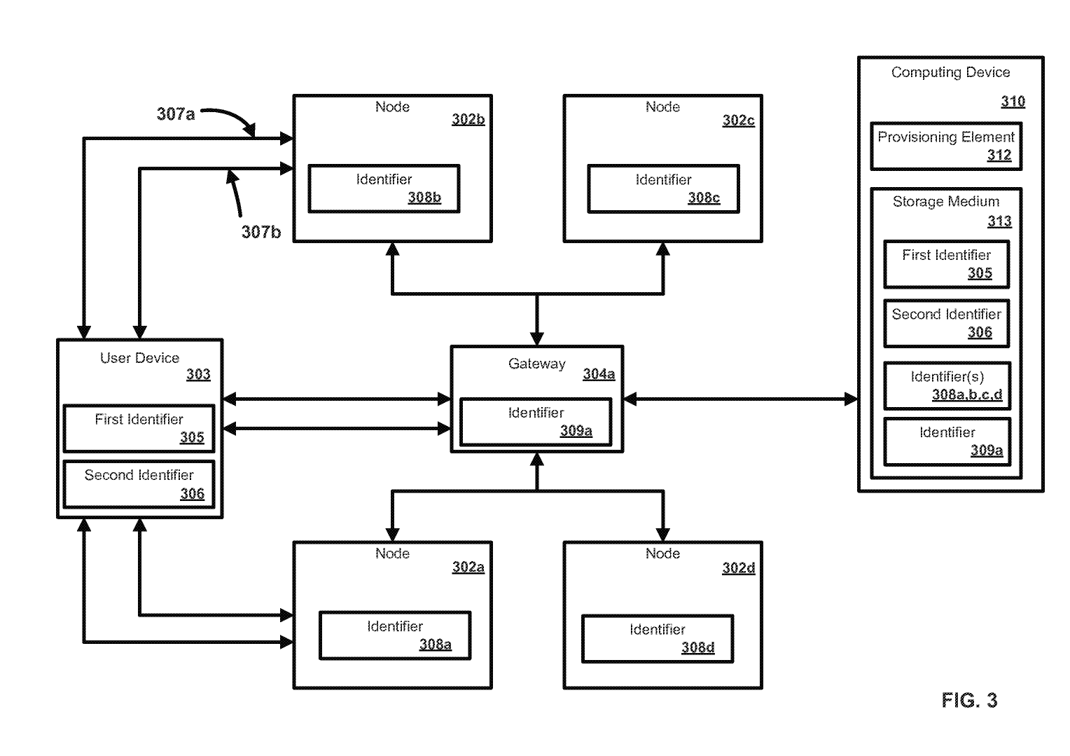

FIG. 3 illustrates an exemplary system and network. In an aspect, a plurality of nodes 302a, 302b, 302c, 302d can be in communication with one or more user devices 303 and a gateway 304a. As an example, one or more nodes 302a. 302b, 302c, 302d can be a network device, router, switch, communication device, or the like. As another example, one or more user devices 303 can be an electronic device such as a computer, a smartphone, a laptop, a tablet, a set top box, a display device, or other device capable of communicating with one or more of the nodes 302a, 302b, 302c, 302d of the network.

In an aspect, the user device 303 can be associated with a first identifier 305 such as a user identifier or device identifier. As an example, the first identifier 305 can be any identifier, token, character, string, or the like, for differentiating one user or user device (e.g., user device 303) from another user or user device. In a further aspect, the first identifier 305 can identify a user or user device as belonging to a particular class of users or user devices. As a further example, the first identifier 305 can comprise information relating to the user device such as a manufacturer, a model or type of device, a service provider associated with the user device 303, a state of the user device 303, a locator, and/or a label or classifier. Other information can be represented by the first identifier 305. In an aspect, the first identifier 305 can be an internet protocol address, a MAC address, a network address, an Internet address, or the like. As an example, the first identifier 305 can be relied upon to establish a communication session between the user device 303 and the computing device 304 or other devices (e.g., nodes 302a, 302b, 302c. 302d) and/or networks. As a further example, the first identifier 305 can be used as an identifier or locator of the user device 303. In an aspect, the first identifier 305 can be persistent for a particular network and/or location.

In an aspect, the user device 303 can be associated with a second identifier 306 such as a user identifier or device identifier. As an example, the second identifier 306 can be any identifier, token, character, string, or the like, for differentiating one user or user device (e.g., user device 303) from another user or user device. In a further aspect, the second identifier 306 can identify a user or user device as belonging to a particular class of users or user devices. As a further example, the second identifier 306 can comprise information relating to the user device such as a manufacturer, a model or type of device, a service provider associated with the user device 303, a state of the user device 303, a locator, and/or a label or classifier. Other information can be represented by the second identifier 306. In an aspect, the second identifier 306 can be an internet protocol address, a MAC address, a network address, an Internet address, or the like. As an example, the second identifier 306 can be relied upon to establish a communication session between the user device 303 and the computing device 304 or other devices (e.g., nodes 302a, 302b, 302c, 302d) and/or networks. As a further example, the second identifier 306 can be used as an identifier or locator of the user device 303. In an aspect, the second identifier 306 can be persistent for a particular network and/or location. In another aspect, the first identifier 305 can be the same or different from the second identifier 306. As an example, the first identifier 305 can be a physical identifier (e.g., MAC address), while the second identifier 306 can be a network identifier (e.g., IP address). As a further example, the first identifier 305 can be a user identifier stored in the device or a device identifier such as international mobile station equipment identity (IMEI), while the second identifier 306 can be a serial number associated with the device. However, other identifiers can be used.

In an aspect, one or more of the nodes 302a, 302b, 302c, 302d can be configured to communicate with another of the nodes 302a, 302b, 302c, 302d and/or the gateway 304 via one or more communication paths. In an aspect, the one or more communication paths can comprise one or more uninterrupted communication links, sequential links, pre-defined paths or links, and/or intervening nodes. Links can comprise a single point to point connection between two devices or network devices. Paths can comprise one or more links. As an example, one or more of the communication paths can comprise one or more of the nodes 302a, 302b, 302c. 302d. As a further example, one or more of the nodes 302a, 302b, 302c, 302d can be configured as a mesh network. In an aspect, one ore more of the communication paths can be configured to transmit one or more services.

In an aspect, the nodes 302a, 302b, 302c, 302d can be configured as a network such as a mesh network. As an example, the gateway 304 and/or one or more nodes 302a, 302b, 302c. 302d can comprise a dual band wireless network device. As an example, a first service 307a or network can be provided. The first service 307a can be configured with a first service set identifier (SSID) (e.g., associated with a user network or private network) to function as a local network for a particular user or users. As a further example, a second service 307b or network can be provided. The second service 307b can be configured with a second service set identifier (SSID) (e.g., associated with a public/community network or a hidden network) to function as a secondary network or redundant network for connected communication devices.

In an aspect, one or more of the nodes 302a, 302b, 302c, 302d can comprise an identifier 308a. 308b. 308c, 308d. As an example, one or more identifiers can be a media access control address (MAC address). Any uniquely identifiable attribute that can be linked to a location can be used as the identifier 308a. 308b, 308c, 308d. Such attributes can comprise one or more of an IP Address, serial number, latitude/longitude, geo-encoding, custom assigned unique identifier, global unique identifier (GUID), and the like. As a further example, one or more identifiers 308a, 308b, 308c, 308d can be a unique identifier for facilitating communications on the physical network segment. In an aspect, each of the nodes 302a. 302b, 302c, 302d can comprise a distinct identifier 308a, 308b, 308c, 308d. As an example, the identifiers 308a, 308b, 308c, 308d can be associated with a physical location of the nodes 302a, 302b, 302c, 302d.

In an aspect, one or more nodes 302a, 302b, 302c, 302d can be in communication with the gateway 304a. As an example, one or more nodes 302a, 302b, 302c, 302d and/or the gateway 304a can be configured to allow one or more wireless devices to connect to a wired and/or wireless network using Wi-Fi. Bluetooth or similar standard. The gateway 304a can comprise an identifier 309a. As an example, one or more identifiers 309a can be a media access control address (MAC address). As a further example, one or more identifiers 309a can be a unique identifier for facilitating communications on the physical network segment.

In an aspect, a computing device 310 can be in communication with a network device such as gateway 304a. As an example, the computing device 310 can be or comprise an application server, management device, auto-configuration server (ACS). AAA server, etc. In another aspect, the computing device 310 is located within a network such as a wide area network (WAN).

In an aspect, the computing device 310 can manage the communication between the gateway 304a, a provisioning element 312, and a storage medium 313 for sending and receiving data therebetween. In an aspect, the provisioning element 312 can be in communication with one or more network devices (e.g., gateway 304a, and/or the nodes 302a. 302b, 302c, 302d) for provisioning one or more of the network devices and/or devices in communication with the networking devices. As an example, the provisioning element 312 can be configured to assign addressable identifiers to one or more of the user device 303, the gateway 304a, and/or the nodes 302a, 302b, 302c. 302d. In an aspect, one or more of the network devices can transmit information to the provisioning system 400. As an example, the transmitted information can comprise information relating to one or more of the user device 303, the gateway 304a, and/or the nodes 302a, 302b, 302c, 302d. As a further example, the transmitted information can comprise an identifier associated with a device seeking communication with one or more networks. In an aspect, the transmitted information can comprise one or more of a MAC Address, a serviceable Address, connectivity, IP Address, Geo-Location, Local DNS Resolver, and the like. In another aspect, the information can be transmitted via a dynamic host configuration protocol (DHCP) request or via remote authentication dial-in user service (RADIUS), for example.

In another aspect, the storage medium 313 can store a plurality of data sets such as mapping objects, first identifiers 305, second identifiers 306, identifiers 308a, 308b, 308c, 308d, and/or identifiers 309 or other information. As a further example, the gateway 304a can request and/or retrieve a file from the storage medium 313. In an aspect, the storage medium 313 can store information relating to the user device 303, the gateway 304a, and/or a relationship between the user device 303 and the gateway 304a. As an example, the computing device 310 can obtain the first identifier 305 from the gateway 304a and retrieve information from the storage medium 313 such as a mapping of the first identifier 305 to the identifier 309a and/or the second identifier 306. The storage medium 313 can be disposed remotely from the computing device 310 and accessed via direct or indirect connection. The storage medium 313 can be integrated with the computing device 310 or some other device or system.

In an aspect, a device such as the user device 303 can request service, such as connectivity to a network or access to applications, by providing information (e.g., credentials, identifiers, etc.) to an access point such as node 302a. As an example, the node 302a can be transmitting a plurality of SSIDs, such as an SSID associated with a public network or service and an SSID associated with a private network or service. As a further example, the user device 302a can receive one or more of the plurality of SSIDs and can use the SSID to request service such as connection to a network (e.g., Internet). As such, the node 302a, the gateway 304a (or other device in communication with the node 302a) can transmit the information received from the user device 303 to the computing device 310. As an example, the node 302a, the gateway 304a and/or the computing device 310 can invoke a lookup algorithm to locate a record (e.g., mapping object) associated with the information provided by the user device 303. As a further example, the record can be located in a network database (e.g., storage medium 313). In a further aspect, the information provided by the user device 303 may be associated with an identifier of the user device 303, the user, one or more nodes 302a, 302b, 302c, 302d and/or one or more gateways 304a. As an example, a database record can comprise a mapping of a device identifier (e.g., first identifier 305) and another identifier (e.g., second identifier 306). As an example, a MAC address associated with the user device 303 can be mapped to a stored IP address. If the information provided by the user device 303 is located in the one or more mapping objects, a local identifier (e.g., IP address, previously or currently issued, of the matching mapping object) can be provisioned to the user device 303 regardless of the SSID or network used to communicate the information. As an example, the user device 303 can connect to a public network, while located within range of a private (e.g., home) network or vice versa. Accordingly, network devices (e.g., gateway 304a, node 302a) can make data (e.g., packet) forwarding decisions (or policy) based on the provisioned local identifier (e.g., second identifier 306). As such, multiple networks associated with different SSID's can interact with the user device 303 as if the user device 303 was connected to a private network such as a home network. Services that are normally exclusively available at the private network can then be accessed outside the private network since data (e.g., packet) routing can be based on the provisioned local IP address to the user device 303.

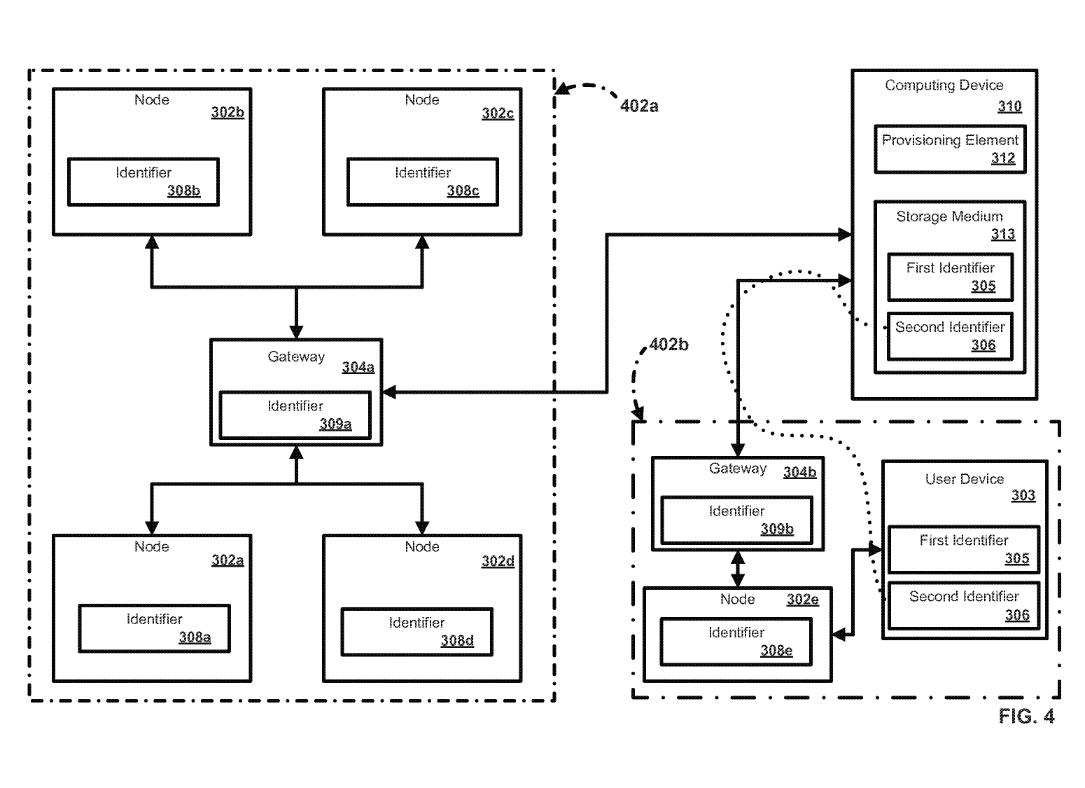

As shown in FIG. 4, a first network 402a can comprise one or more of the nodes 302a, 302b, 302c, 302d and/or the gateway 304a and a second network 402b can comprise one or more nodes (e.g., node 302e) and/or a gateway 304b. In an aspect, each of the first network 402a and the second network 402b can be associated with an identifier such as an SSID. As an example, the first network 402a can be a home network and can be associated with a private SSID, while the second network 402b can be an open, public network associated with a public SSID.

In an aspect, a device such as the user device 303 can request service, such as connectivity to a network or access to applications, by providing information (e.g., credentials, identifiers, etc.) to an access point such as node 302e and/or the gateway 304b. The gateway 304b can transmit the information received from the user device 303 to the computing device 310. As an example, the gateway 304b and/or the computing device 310 can invoke a lookup algorithm to locate a record (e.g., mapping object) associated with the information provided by the user device 303. As a further example, the record can be located in a network database (e.g., storage medium 313). In a further aspect, the information provided by the user device 303 may be associated with an identifier of the user device 303, the user, one or more nodes 302a. 302b, 302c, 302d, 302e and/or one or more gateways 304a, 304b. As an example, a database record can comprise a mapping of a device identifier (e.g., first identifier 305) and another identifier (e.g., second identifier 306). As an example, a MAC address associated with the user device 303 can be mapped to an IP address that is associated with the first network 402a (e.g., home network) to which the user device 303 previously connected (FIG. 3). If the device identifier is located in the one or more mapping objects, the local identifier (e.g., IP address, previously or currently issued, of the matching mapping object) can be provisioned to the user device 303 even though the user device 303 may have been associated to a network (e.g., second network 402b) other than the first network. As an example, the user device 303 can connect to a public network, while located within range of a private home network. As a further example, the user device 303 can connect to a network outside the range of the home network. Accordingly, network devices (e.g., gateway 304b, node 302e) can make data (e.g., packet) forwarding decisions (or policy) based on the provisioned local identifier (e.g., second identifier 306). As such, multiple networks associated with different SSID's can interact with the user device 303 as if the user device 303 was connected to the first network 402a (e.g., home network). Services that are normally exclusively available at the first network can then be accessed outside the first network since data (e.g., packet) routing can be based on the provisioned local IP address to the user device 303.

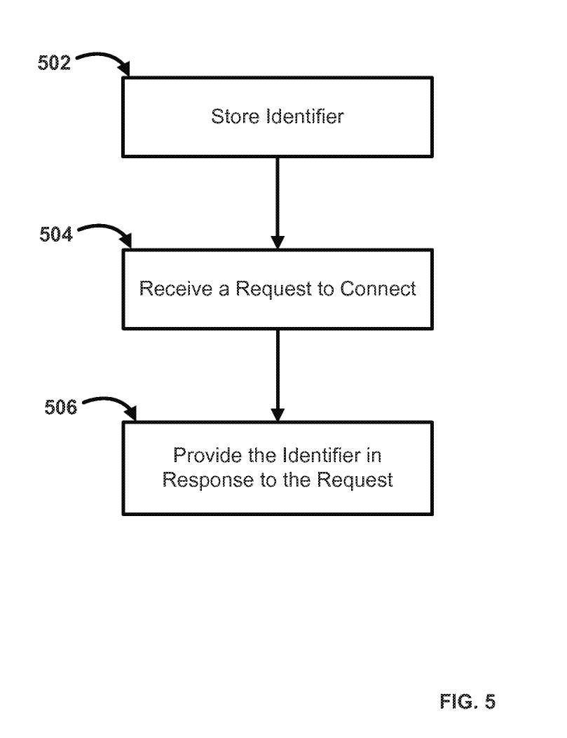

In an aspect, provided are methods for provisioning and deploying a network. An exemplary method is shown in FIG. 5. In step 502, an identifier can be stored. In an aspect, the identifier can be or comprise a MAC address, an IP address, telephone number, serial number, or a combination thereof. The identifier can also relate to the user's account or subscription information. In another aspect, the identifier can be associated with one or more of a user or user device and a first network device. As an example, the first network device can be at a first location and can be configured to establish a connection between a user device and a first network such as a private network or public network. In a further aspect, the identifier can be stored as a data set with an association with other information such as another identifier. For example, the identifier can be stored as a mapped object with another identifier (e.g., first identifier mapped to second identifier, MAC address mapped to IP address, etc.). The identifier can be stored in a cache (local or remote to the user/user device), external memory, network memory, etc.

In step 504, a request can be received from a user device. The request can comprise information identifying the user device or a user. In an aspect, the request can relate to connecting to a network such as a first or second network. As another aspect, the request can be received via the second network and/or a second network device. The second network device can be at a second location different from the first location. As an example, the first network device can be part of a first network and the second network device can be part of the second network. As another example, the first network device can be the same device as the network device and can facilitate connection to a plurality of networks (e.g., the first and second network). As another example, one or more of the first network and the second network is a private network or public network. As a further example, the first network can be a private network and the second network can be a public network. Other networks and configurations can be implemented.

In step 506, the stored identifier can be provided (e.g., provisioned, assigned, transmitted, retrieved, accessed) in response to the request. In an aspect, the stored identifier can facilitate connection to the first network. In another aspect, the stored identifier can facilitate connection to the second network (e.g., via the second network device) as if the user device was connected to the first network. As an example, the stored identifier facilitates data transmission (e.g., packet forwarding) via the to the user device. As another example, stored identifier facilitates data transmission (e.g., packet forwarding) to the user device as if the user device was connected to the first network, regardless of the location of the user device or the network through which the request was received.

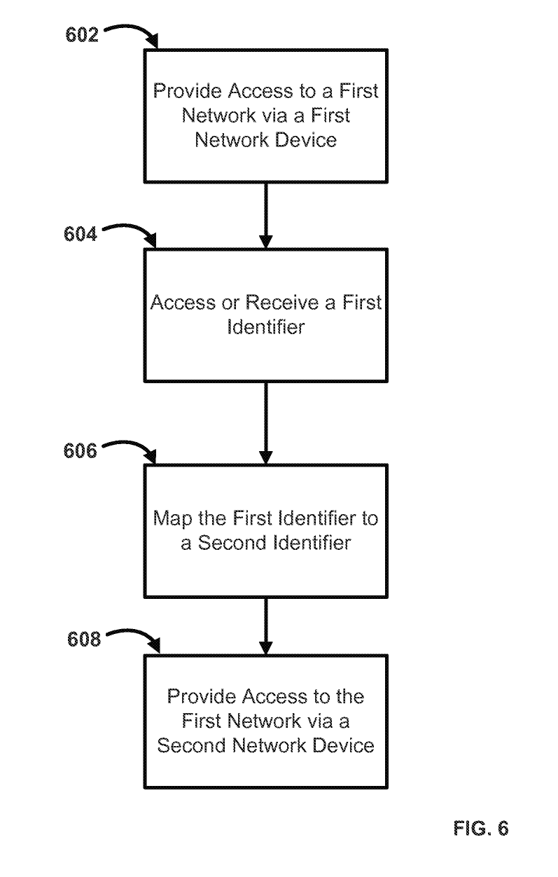

Another exemplary method is shown in FIG. 6. In step 602, access to a first network (e.g., LAN) can be provided. In an aspect, providing access to the first network can comprise transmitting (e.g., broadcast, unicast, beacon, etc.) a service identifier such as an SSID. The first network can be a private network (e.g., home network). In a further aspect, the first network can be a public network. The access to the first network can be provided via a first network device.

In step 604, a first identifier can be accessed or received. In an aspect, the first identifier is associated with a user device. In an aspect, the first identifier can be or comprise an addressable identifier (e.g., MAC address) associated with the user device. In another aspect, the first identifier can be received as part of a DHCP request.

In step 606, the first identifier can be associated (e.g., mapped) to a second identifier. In an aspect, the second identifier can be associated with the first network device and can comprise an IP address or another identifiable mark or string. As an example, the second identifier can be or comprise an IP address local to the first network device.

In step 608, access to the first network can be provided via a second network device. In an aspect, access can be provided using one or more of the first identifier and the second identifier. In another aspect, a user device can request access to the first network via the second network device using the first identifier. The first identifier can be used to find a matching, e.g., mapped object, such as a mapping of the first identifier and the second identifier. If the first identifier is found corresponding with the second identifier, the second identifier can be used, e.g., provisioned, to the user device to facilitate access to the first network via the second network device. In an aspect, the second identifier facilitates connection to the first network via the second network device as if the user device was connected to the first network via the first network device. In another aspect, the second identifier facilitates transmission, e.g., packet forwarding, via the first network to the user device.

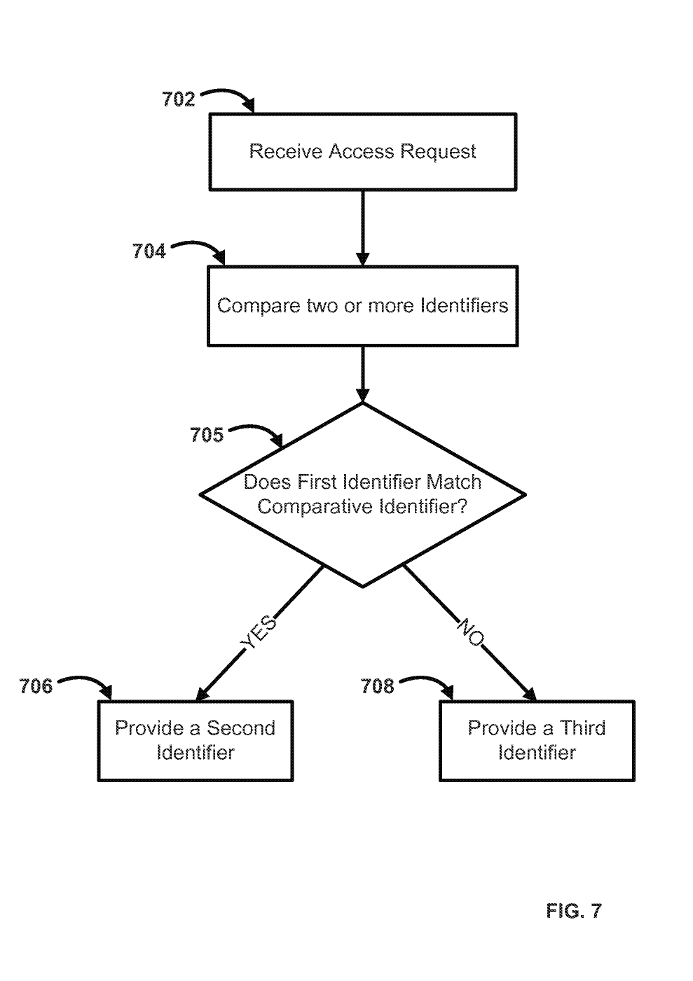

FIG. 7 presents another example method for provisioning and deploying a network. In step 702, an access request can be received from a device such as a user device. In an aspect, the access request can relate to a service such as a broadband service, network connectivity, access to data or content, service set, etc. The requesting device can be associated with a first identifier. As an example, the first identifier can be associated with the user device. As a further example, the first identifier can be or comprise a MAC address or relate to a user's account or subscription information.

In step 704, two or more identifiers can be compared. In an aspect, the first identifier can be compared with a received or stored identifier. In another aspect, the first identifier can be compared to stored data sets to determine if a network has a relationship (e.g., mapped object, mapped pair) with the user device associated with the first identifier.

In step 705, it can be determined whether the first identifier matches any of the comparative (e.g., stored) identifiers. If the first identifier matches the stored identifier, a second identifier (e.g., stored second identifier) can be provided (e.g., provisioned, transmitted, assigned) to the user device to satisfy the access request, at step 706. As an example, the second identifier can comprise an IP address (e.g., an IP address associated with a LAN such as a home network), a VLAN label, and/or an multiprotocol label switching (MPLS) label. Matching can comprise an exact match and/or a partial match. As an example, locating a match between the first identifier and a comparative stored identifier can indicate that the user or device associated with the first identifier is known or has connected to a previous network. As such, a second identifier such as an IP address associated with the previous network can be provided to the device regardless of the SSID or network used to communicate the access request. As an example, the user device can connect to a public network, while located within or outside range of a private (e.g., home) network. Accordingly, network devices of the public network can make data (e.g., packet) forwarding decisions (or policy) based on the provisioned second identifier. As such, multiple networks (private and public) associated with different SSID's can interact with the user device as if the user device was connected to a private network such as a home network. Services that are normally exclusively available at the private network can then be accessed outside the private network since data (e.g., packet) routing can be based on the provisioned local IP address to the user device.

If the first identifier does not match the stored identifier, a third identifier can be provided to the user device to satisfy the access request, at step 708. As an example, the third identifier can comprise an IP address (e.g., an assigned IP address for a public network), a VLAN label, and/or an MPLS label. In an aspect, the second identifier is different from the third identifier. As a further example, the third identifier can be provisioned based on a default or preset provisioning process associated with the network used to transmit the access request. However, the third identifier can be associated with other networks or devices.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
storing an identifier associated with one or more of a user device and a first network device, wherein the first network device is at a first location and is configured to establish a connection between the user device and a first network;
receiving a request to connect from the user device via a second network; and
providing the identifier in response to the request, wherein the identifier facilitates data transmission as if the user device was connected to the first network via the first network device.

2. The method of claim 1, wherein the first network is a private network.

3. The method of claim 1, wherein the second network is a public network.

4. The method of claim 1, wherein the identifier comprises a MAC address, an IP address, or both.

5. The method of claim 1, wherein storing an identifier comprises mapping the identifier to a second identifier and wherein the second identifier is associated with one or more of a user device and a first network device.

6. The method of claim 5, wherein the second identifier comprises a MAC address, an IP address, or both.

7. The method of claim 1, wherein providing the identifier comprises assigning the identifier to the user device and wherein the identifier facilitates data forwarding via the second network to the user device.

8. The method of claim 1, wherein the receiving a request to connect from the user device is via a second network device at a second location.

9. A method comprising:
providing access to a first network via a first network device;
receiving a first identifier associated with a user device;
mapping the first identifier to a second identifier, wherein the second identifier is associated with the first network device; and
providing access to the first network via a second network device using one or more of the first identifier and the second identifier.

10. The method of claim 9, wherein the network is a local area network.

11. The method of claim 9, wherein the first identifier comprises a MAC address.

12. The method of claim 9, wherein the first identifier is received as part of a DHCP request.

13. The method of claim 9, wherein the second identifier comprises an IP address.

14. The method of claim 9, wherein one or more of the first network device and the second network device comprises a gateway.

15. A method comprising:
receiving an access request from a user device, wherein the user device is associated with a first identifier,
comparing the first identifier with one or more stored identifiers;
if the first identifier matches a stored identifier of the one or more stored identifiers, providing a second identifier to the user device to satisfy the access request; and
if the first identifier is different from the one or more stored identifiers, providing a third identifier to the user device to satisfy the access request, wherein the stored third identifier is different from the third identifier.

16. The method of claim 15, wherein the access request relates to network access.

17. The method of claim 15, wherein the first identifier comprises a MAC address.

18. The method of claim 15, wherein the one or more stored identifiers comprises a MAC address.

19. The method of claim 15, wherein the second identifier comprises one or more of a stored IP address, VLAN label, and MPLS label.

20. The method of claim 15, wherein the third identifier comprises one or more of an IP address, VLAN label, and MPLS label.
